(19) United States
(12) Patent Application Publication
(10) Pub. No.: US 2017/0006376 A1
(43) Pub. Date: Jan. 5, 2017

(54) Improved Omnidirectional Speaker With Soundwave Deflectors

(71) Applicant: DREAM AUDIOLAB PTE LTD, Singapore (SG)

(72) Inventor: Kok Leong TAN, Singapore (SG)

(21) Appl. No.: 15/106,450

(22) PCT Filed: Dec. 16, 2014
(86) PCT No.: PCT/SG2014/000597

§ 371 Date: Jun. 20, 2016

(30) Foreign Application Priority Data
Dec. 20, 2013 (SG) 201309478-4

(51) Int. Cl. H04R 1/34; H04R 1/24

(52) U.S. Cl. CPC H04R 1/345; H04R 1/24

(57) ABSTRACT

An omnidirectional speaker 10 having drivers 11, 21, 31 and corresponding waveguides 12, 22, 32, which have a base and a raised centre. Soundwave deflectors 40 are arranged radially on the surfaces of the waveguides 12, 22, 32, such that in use, the soundwave deflectors 40 are adapted to distribute and disperse sound waves produced by the drivers 11, 21, 31 and reflected off of the waveguides 12, 22, 32.

### FIELD OF THE INVENTION

This invention relates to omnidirectional speakers, and more particularly to an omnidirectional speaker with improved sound quality.

### BACKGROUND OF INVENTION

Omnidirectional speakers are speakers which provide a sound field which allows a person positioned in any direction around the speaker to hear the wide bandwidth (frequency range) sound produced by the speaker. Such speakers utilise drivers which are transducers that convert electricity to various ranges of sound frequencies. A diaphragm in the driver is electrically induced in a back-and-forth motion to create pressure waves in a column of air in front of the driver, and at some angles to the sides. The diaphragm is typically in the shape of a cone.

It is commonly known in the art to use multiple drivers to enhance sound quality, where the different drivers used, comprise commonly of low frequency drivers (woofers or sub-woofers) which produce sound in a low frequency range, midrange frequency drivers which produce sound in a middle frequency range, and high frequency drivers (tweeters) which produce sound in a high frequency range. Breaking up a sound signal in this manner has been found to advantageously cover the range of sounds a human can hear, which range is on average 20 Hz to 15,000 Hz.

High-fidelity sound reproduction in speakers, i.e. the desire to have the reproduced sound being as close as possible to the original sound recorded, is highly sought after. A wide variety of omnidirectional speaker designs have been created in an effort to enhance sound quality and to achieve high-fidelity sound reproduction. For example, known speaker designs include U.S. Pat. No. 5,115,882 to Woody. Woody discloses a speaker comprising a pair of drivers, one tweeter and one midrange, with each driver aligned in the same direction. Each driver is also provided with a conical shaped dispersion surfaces. However, irregular surfaces, such as the tip of the conical shaped dispersion surface, have been found to introduce distortions in sound quality. Such conical shaped waveguides have proved to be less than ideal. In general, irregular surfaces produce reflections in sound waves which are out of phase with other sound waves generated by the speaker, and can also result in reinforcement of some frequencies and cancellation of others.

U.S. Pat. No. 5,673,329 to Wiener discloses a midrange driver with a relatively smooth sound dispersion element (waveguide), with the diameter of the sound dispersion element being larger than that of the midrange driver. However, the sound waves produced by the midrange driver and reflected off of the sound dispersion element is not evenly distributed outwards away from the speaker. The uneven dispersion of sound waves may introduce distortions and vary sound quality levels at various positions around the speaker.

It would therefore be desirable to provide an omnidirectional speaker with well-distributed sound dispersion, and with enhanced and consistent sound quality.

### SUMMARY OF INVENTION

According to a first aspect of the invention, there is provided an omnidirectional speaker comprising at least one speaker driver, at least one waveguide corresponding to the at least one speaker driver, and two or more tapered soundwave deflectors arranged radially on the at least one waveguide, such that in use, the soundwave deflectors are adapted to distribute and disperse sound waves produced by the at least one speaker driver and reflected off of the at least one waveguide.

Preferably, the soundwave deflectors have a thick edge and a thin edge, and the soundwave deflectors tapering from the thick edge to the thin edge, wherein the thin edge is closer to the centre of the waveguide than the thick edge.

Preferably, the soundwave deflectors have a smooth outer peripheral surface free of irregularities, discontinuities and/or abrupt transitions.

Preferably, the at least one waveguide has a differentiable surface. Even more preferably, the at least one waveguide has a smooth surface, free of irregularities, discontinuities and/or abrupt transistions.

Preferably, the surface of the at least one waveguide is continuous with the surface of the soundwave deflectors, such that the transition between the two surfaces is smooth and free of irregularities, discontinuities and/or abrupt transitions. The at least one waveguide and the soundwave deflectors may be a single piece or of unitary construction.

Preferably, the omnidirectional speaker has 2 to 10 soundwave deflectors on the at least one waveguide. Even more preferably, there are 6 or 10 soundwave deflectors on the at least one waveguide.

Preferably, the soundwave deflectors are identical in shape, size and height, and are located at the same distance from the raised centre, as well as from each other, on the at least one waveguide.

Preferably, the at least one waveguide has a base with a raised centre, the raised centre facing the at least one speaker driver.

Preferably, the waveguide tapers in a concave manner from the base to the raised centre.

Preferably, the at least one waveguide is convex.

Preferably, the at least one speaker driver has a first diameter, and the at least one waveguide has a second diameter, and wherein the second diameter is larger than the first diameter.

It is preferred that the omnidirectional speaker further comprises a housing. Preferably, the part of the surface of the soundwave deflectors furthest from the centre of the at least one waveguide, is substantially continuous with the peripheral surface of the housing.

It is preferred that the omnidirectional speaker has two speaker drivers: a first high frequency driver and a second mid-range frequency driver.

Preferably, the omnidirectional speaker has two waveguides: a first high frequency waveguide corresponding to the first high frequency driver and a second mid-range frequency waveguide corresponding to the second mid-range frequency driver.

Preferably, the first high frequency driver faces the second mid-range frequency driver.

Preferably, the high and midrange frequency waveguides are positioned between the first high frequency driver and the second mid-range frequency driver so as to block a direct path from the first high frequency driver to the second mid-range frequency driver.

Preferably, the omnidirectional speaker includes a low frequency driver.

From the foregoing disclosure and the following more detailed description of various embodiments it will be apparent to those skilled in the art that the present invention provides a significant advance in the technology of speakers. Particularly significant in this regard is the potential the invention affords for providing a high quality, improved omnidirectional speaker. Additional features and advantages of various embodiments will be better understood in view of the detailed description provided below.

### BRIEF DESCRIPTION OF THE DRAWINGS

The present invention will now be described, by way of example only, with reference to the accompanying drawings.

FIG. 1 is an exploded isometric view of an embodiment of an improved omnidirectional speaker in accordance with the present invention.

FIG. 2 is a cross section view of the high and mid-range frequency drivers' portions of the improved omnidirectional speaker of FIG. 1, viewed from A to A′ or A′ to A.

FIG. 3 is a cross section view of the high and mid-range frequency drivers portions of the improved omnidirectional speaker of FIG. 1, viewed from B to B′ or B′ to B.

FIG. 4 is a perspective view of an embodiment of a waveguide of an improved omnidirectional speaker in accordance with the present invention.

FIG. 5 is a top view of the waveguide of FIG. 4.

FIG. 6A is side view of the waveguide of FIG. 5, viewed from C to C′ or C′ to C.

FIG. 6B is a side view of the waveguide of FIG. 5, viewed from D to D′ or D′ to D.

FIG. 7 is an enlarged side view of a section of the improved omnidirectional speaker of FIG. 1.

FIG. 8 is a cross section view of the high and mid-range frequency drivers' portions of a second embodiment of the present invention.

FIG. 9 is a cross section view of the high and mid-range frequency drivers' portions of a third embodiment of the present invention.

It should be understood that the drawings are not necessarily to scale. The drawings simply present a representation of the features involved in the working of the present invention. The specific dimensions of the present invention, may be determined in part by the particular intended application and use environment, for example, the number of soundwave deflectors may depend on the size of the waveguide on which they are arranged or on the environment in which the present invention is used.

### DETAILED DESCRIPTION OF THE DRAWINGS

It will be apparent to those skilled in the art, that is, to those who have knowledge or experience in this area of technology, that many uses and design variations are possible for the omnidirectional speakers disclosed here. The following detailed discussion of various alternate features and embodiments will illustrate the general principles of the invention with reference to an omnidirectional speaker suitable for use in home entertainment systems. Other embodiments suitable for other applications will be apparent to those skilled in the art given the benefit of this disclosure. It will be understood that the embodiments described are intended to be illustrative of the general inventive concept, and not limitative thereof.

In the present disclosure, any depiction of a given element or use of a particular element number in a particular figure or a reference thereto in corresponding descriptive material, can encompass the same, an equivalent, or an analogous element or element number indicated or identified in another figure or descriptive material associated therewith.

For the purposes of the description and the claims, the term “diameter” refers to, corresponds with or is defined as the length of a straight line segment passing through the centre of a body, shape or figure, from one end to another end, and includes, without limitation, the longest and narrowest portion of the body, shape or figure.

For the purposes of the description and the claims, the term “differentiable” refers to, corresponds with or is defined as being entirely from or nearly entirely from a continuous function, such as a parabola, ellipse, etc.

It will be understood by those skilled in the art that, in general terms, a tweeter or a high frequency driver may generate sound over a range of about 2000 Hz to about 20 KHz and above, a mid-range frequency driver may generate sound over a range of about 160 Hz to about 8000 Hz, and a woofer or low frequency driver may generate sound over a range of about 20 Hz to about 500 Hz. Generally, all the frequencies are in a range audible to humans, and the frequency ranges of the tweeter, mid-range driver and woofer may overlap. Of course, the precise limits of these ranges may be varied from component to component, as would be understood by those skilled in the art.

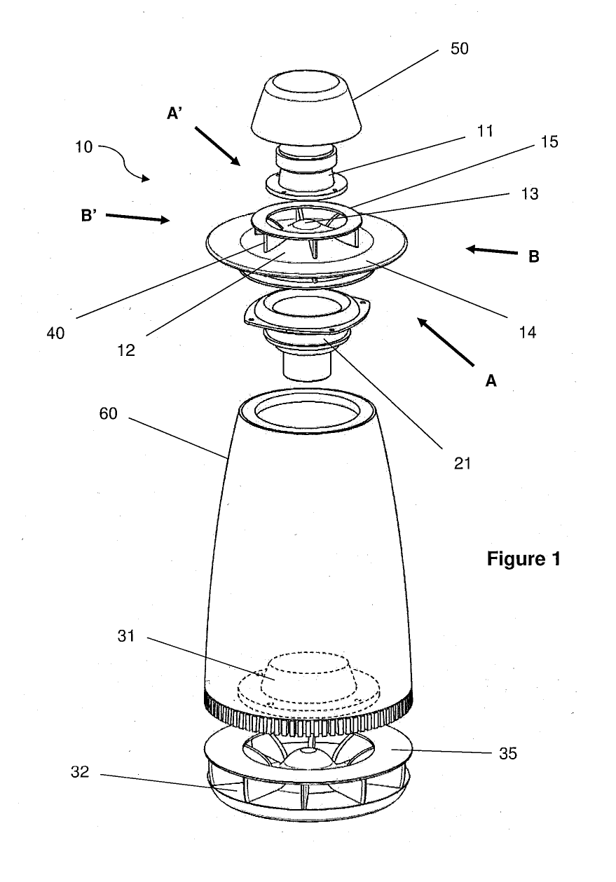

Turning now to the drawings, FIG. 1 shows an improved omnidirectional speaker 10 in accordance to the present invention. The speaker 10 has a tweeter 11, mid-range frequency driver 21 and a woofer 31. The number and type of drivers used in speaker 10 may vary, for example, there may be more than three drivers in speaker 10, and for example, the mid-range frequency driver 21 may be a hybrid driver, having a frequency range covering both low and mid-range audio frequencies. Further, the placement and order of the drivers in speaker 10 may change, for example, the tweeter 11 may be placed in between the mid-range frequency driver 21 and woofer 31. Given the nature and energy of low audible frequencies, woofer 31 may exist separately in another speaker system (not shown), alone or in combination with other drivers, the separate woofer system capable of being electrically connected to the main omnidirectional speaker 10. The speaker 10 may also include a passive radiator. All of the drivers are electrically connected together.

Each driver 11, 21, 31 is located within a housing 50, 60. Tweeter 11 is housed within housing 50 while mid-range frequency driver 21 and woofer 31 are housed within housing 60. Optionally, mid-range frequency driver 21 and woofer 31 may not share the same housing and may be located within separate housings, especially in the configuration where the woofer 31 is located separately from speaker 10. The housings 50, 60 may also include sound absorbing material. The drivers 11, 21, 31 are secured to the housings 50, 60 using suitable fasteners.

Sound produced by the drivers 11, 21, 31 is reflected by a corresponding waveguide 12, 22, 32, out to listeners. Tweeter waveguide 12 corresponds to tweeter 11, mid-range frequency driver waveguide 22 corresponds to mid-range frequency driver 21 and woofer waveguide 32 corresponds to woofer 31. Given the energy of sound waves at low frequencies, woofer waveguide 32 may be omitted.

Soundwave deflectors 40 are arranged radially on the surface of each waveguide 12, 22, 32. While tweeter waveguide 12 shows six deflectors 40 and woofer waveguide 32 show eight deflectors 40, it should be understood that the number of deflectors are not fixed or limited to these numbers. The number of deflectors 40 may also be even or odd. The number of deflectors 40 may depend on the size of the waveguide on which the deflectors 40 are arranged or on the environment in which the speaker 10 is used. Supporting means 15, 25, 35 are provided on a portion of the deflectors 40 closest to the housings 50, 60. The supporting means 15, 25, 35 abut the peripheral edge of housings 50, 60 to maintain the drivers 11, 21, 31 and housings 50, 60, at a predetermined distance from the waveguides 12, 22, 32. It is understood that the supporting means 15, 25, 35 need not be a unitary annular frame as shown in FIG. 1, and may be separate individual portions located on the deflectors 40. Optionally, the supporting means 15, 25, 35 may be omitted and the deflectors 40 directly abut against the peripheral edge of housings 50, 60.

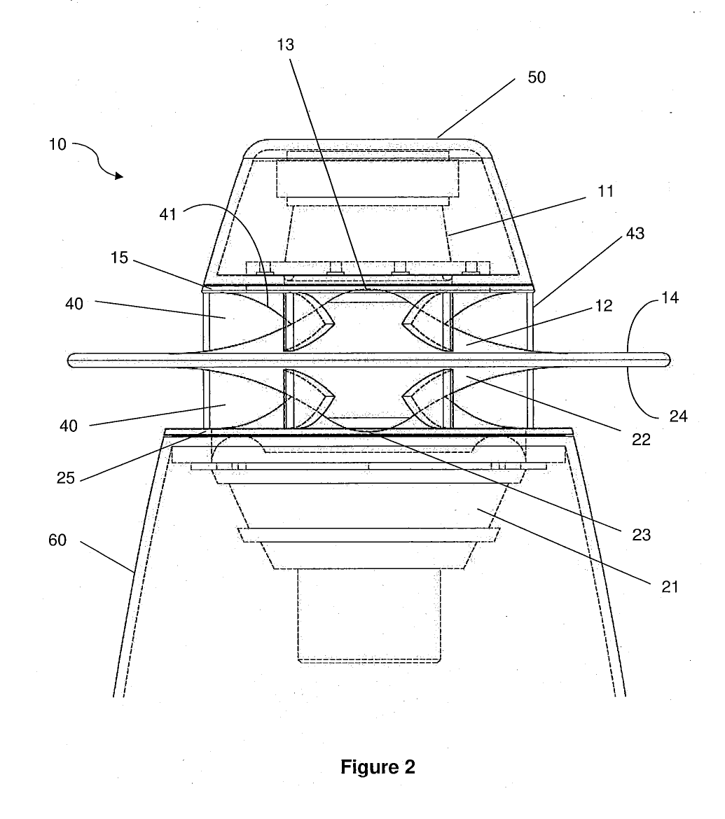

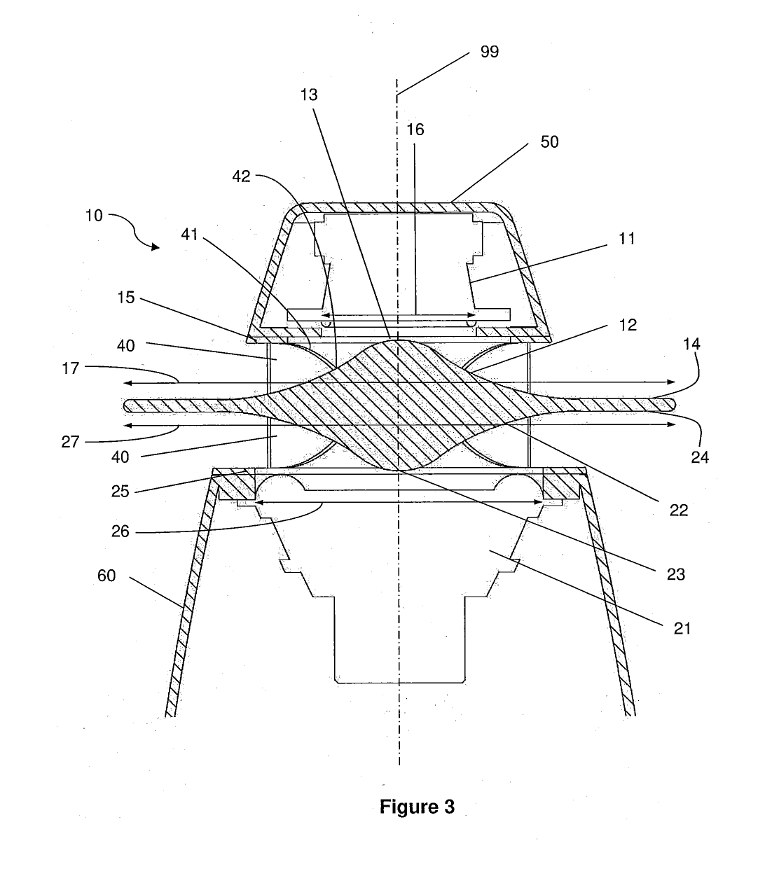

FIGS. 2 and 3 show the tweeter waveguide 12 and mid-range frequency driver waveguide 22 in more detail (properties of these waveguides 12, 22 described herein, would also be applicable for the woofer waveguide 32). Each waveguide 12, 22 has a base 14, 24, and an apex 13, 23, which is a raised centre portion of the waveguide 12, 22. The tweeter waveguide 12 faces the tweeter 11, while the mid-range frequency driver waveguide 22 faces the mid-range frequency driver 21, where the apices 13, 23 of each waveguide is the closest to the drivers and the bases 14, 24 is the furthest from the drivers. It is preferable that the closest distance between the apices of waveguides 12, 22, 32 and the front of their corresponding drivers 11, 21, 31, be at least 25 mm.

Each waveguide 12, 22 tapers from the base 14, 24 in a concave manner, towards the apex 13, 23. It is also understood that the waveguides 12, 22 can be entirely convex, taking the shape of a hemisphere. While the shape of the waveguides 12, 22 has been defined as above, it should however be understood that such definitions serve only as a guide and should not be limited to the precise mathematical description of such geometries. It is found to be more important that the surfaces of the waveguides 12, 22 be differentiable. Such differentiable surfaces may have a non-continuous slope to avoid an abrupt transition at apices 13, 23. This avoids irregular surfaces, points, etc., which would introduce distortions into sound waves. It is also important that the surfaces of the waveguides be smooth and free of irregularities, discontinuities and/or abrupt transitions. Differentiable and smooth surfaces reduce, minimise and eliminate unwanted turbulence in the sound waves reflected off the surface of the waveguide, which would result in the reduction in sound quality. Other smooth surfaces and geometries suitable for use as a waveguide will be readily apparent to those skilled in the art given the benefit of this disclosure.

With reference to FIG. 3, tweeter 11 has a first diameter 16 and the tweeter waveguide 12 has a second diameter 17; mid-range frequency driver 21 has a third diameter 26 and the mid-range frequency driver waveguide 22 has a fourth diameter 27. Second diameter 17 is larger than the first diameter 16 and fourth diameter 27 is larger than first diameter 26. In FIG. 3, while second diameter 17 corresponds to fourth diameter 27, it should be understood that these two diameters may be different in length. This similarly applies to the diameter of the woofer waveguide 32. As a guide, each waveguide diameter can be calculated as a ratio of the combined drivers' diameters in the present invention. It is important that each waveguide diameter is larger than the diameter of the corresponding driver.

The waveguides 12, 22, 32 have a generally circular cross section when viewed from above or below (shown in FIG. 5) which corresponds to the generally circular shape of each driver 11, 21, 31. Other shapes, such will also serve as a proper waveguide, provided the shortest straight line length from one end to the other end of the waveguide, passing through its centre, is larger than a diameter of the corresponding driver. For example, if the waveguide has an elliptical shape, the diameter along the minor axis of the ellipse, should be larger than the diameter of the corresponding driver.

According to FIGS. 2 and 3, tweeter 11 faces the mid-range frequency driver 21, with the waveguides 12, 22 are located between the two drivers to block a direct path from the tweeter 11 to the mid-range frequency driver 21, and vice versa. In such a configuration, the waveguides 12, 22 may be formed as a single piece or unitary construction. It should however be understood that the drivers may be arranged such that they face the same direction instead, for example, tweeter 11 faces the back of mid-range frequency driver 21, with the tweeter waveguide 12 being located between the tweeter 11 and the mid-range frequency driver 21. Each of the drivers 11, 21, 31 has a centre, and the centres of each driver are aligned with one another, such as at axis 99.

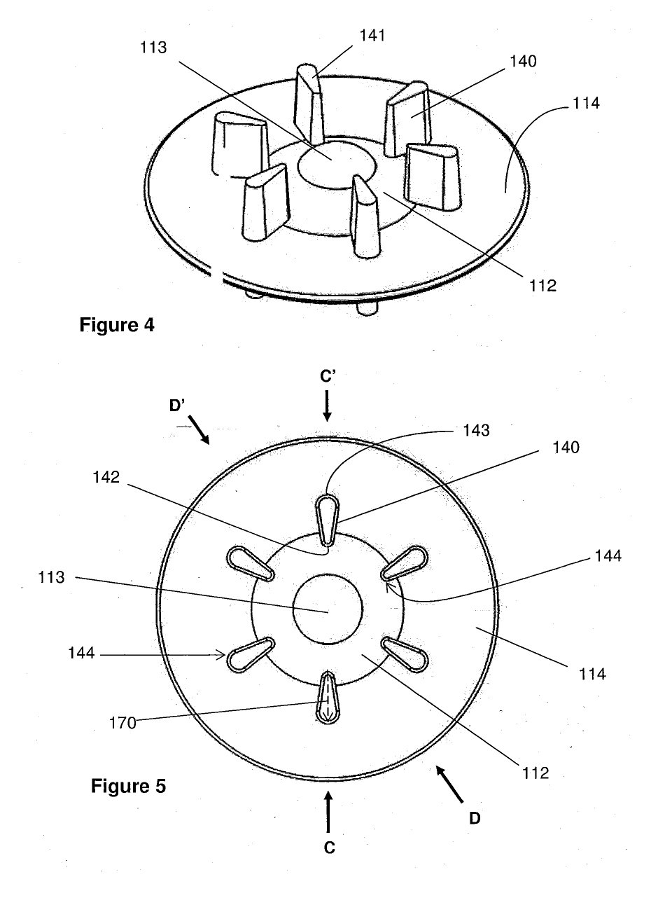

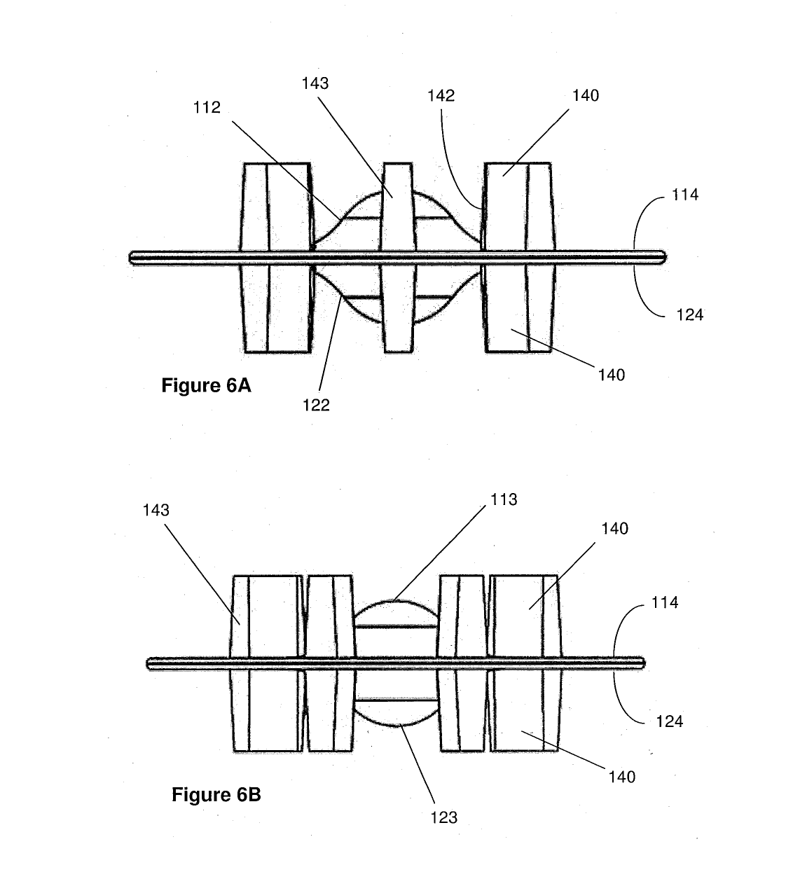

FIGS. 4 to 6B show another embodiment of the waveguides of the present invention where the soundwave deflectors are more clearly depicted. As shown in FIGS. 4 and 5, the deflectors 140 are preferably substantially similar, i.e. having the same shape, size and height, and are at the same distance from the centre as well as from one other on the waveguide 112. However, it is understood that the similarity of the deflectors depend on the particular intended application and use environment of the present invention, for example, the waveguide may have deflectors of two different sizes where alternate deflectors are of the same size.

It is preferable for the deflectors 140 to have a tapered shape when the waveguide 112 is viewed from above, as shown in FIG. 5. The deflectors 140 have a. front thick edge 143 and a rear thin edge 142, where the deflectors 140 taper from the thick edge 143 to the thin edge 142. The thin edge 142 is the closest to the apex 113 and the thick edge 143 is the furthest from the apex 113. The deflectors 140 deflect sound waves without destroying them while the tapered shape of the deflectors 140 creates gradually widening guiding channels between neighbouring deflectors, where each channel helps to distribute and guide out sound waves reflected off the waveguides 112 to the listener. The deflectors 140 and guiding channel improve the directivity of the sound waves propagating in an omnidirectional manner.

The deflectors 140 have a smooth outer peripheral surface free of irregularities, discontinuities and/or abrupt transitions. The corners 144 of the deflectors 140 are rounded to avoid any irregularities and abrupt transitions on the surface of the deflectors 140. The transition between the surface of the waveguides 112, 122 and their respective deflectors 140 is preferably continuous, smooth and free of irregularities, discontinuities and/or abrupt transitions. The waveguides 112, 122 and their respective deflectors 140 may be formed as a single piece or unitary construction. The shape and smooth surface of the deflectors 140 is important for the reduction, minimisation and/or elimination of turbulence in the sound waves, and to distribute and disperse the soundwaves reflected off the waveguide 112, preferably in an even manner out to listeners. Each deflector 40 has a length 170, measured from the thick edge 143 to the thin edge 142.

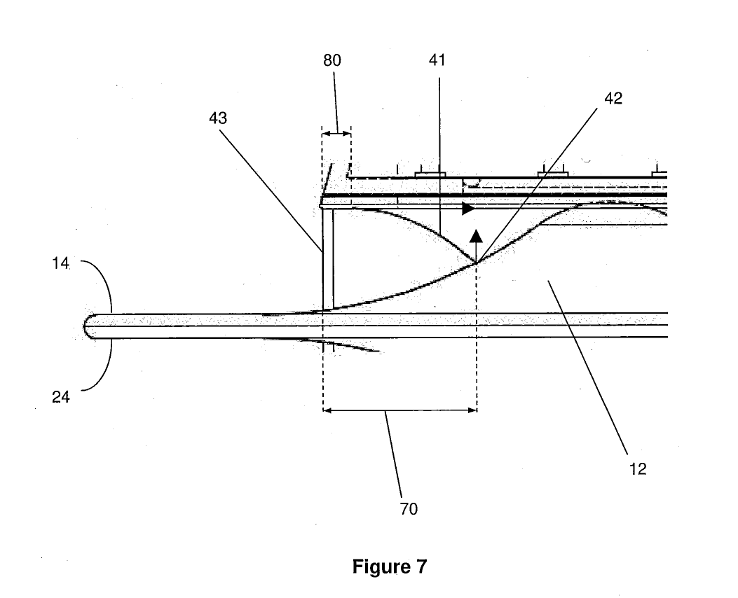

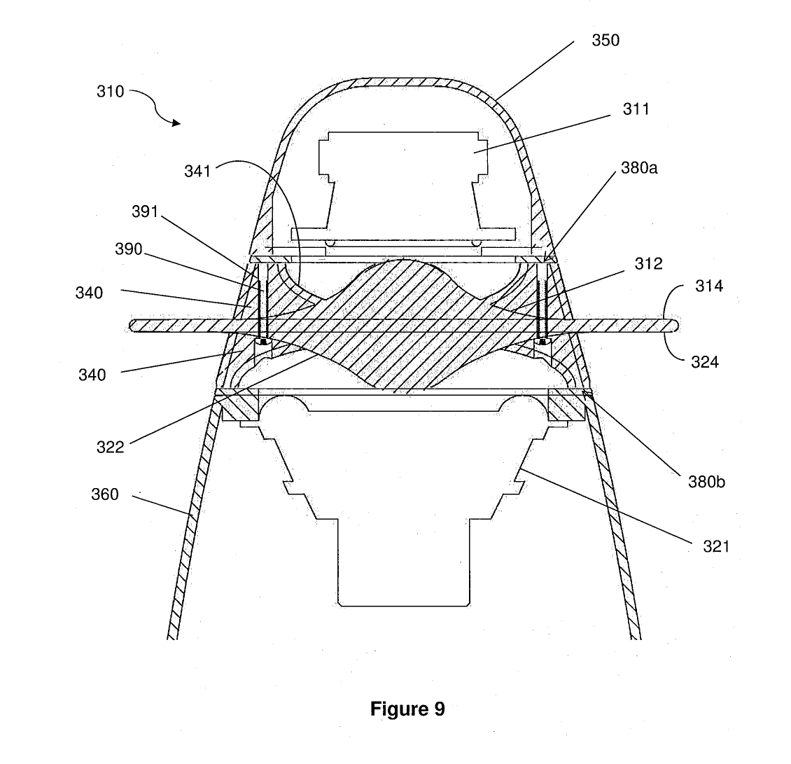

Each deflector 140 has a spine 141 which can directly abut against the housing of a driver corresponding to the waveguide the deflector is located, the driver. itself, or against a supporting/spacing means which sets the waveguide at a predetermined distance from the corresponding driver. FIG. 7 shows a side profile of a deflector 40 according to the embodiments of FIGS. 1-3. Deflector 40 has a spine 41 which curves from the top of the deflector down towards the surface of the waveguide 12. Spine 41 is substantially horizontal for a predetermined distance at portion 80 at the top of the deflector 40 from the front thick edge 43, before it starts to curve down towards the surface of waveguide 112. As a guide, the total length 70 of a deflector 40 and the predetermined distance at portion 80 can be calculated as a ratio of the combined drivers' diameters in the present invention. While FIG. 7 shows the spine 41 curving in a convex manner, the spine 41 may also curve in a concave manner down towards the surface of the waveguide—an example is shown in the embodiment of FIG. 9 where the spines 341 of deflectors 340 curves in a concave manner towards the surface of the waveguides 312, 322.

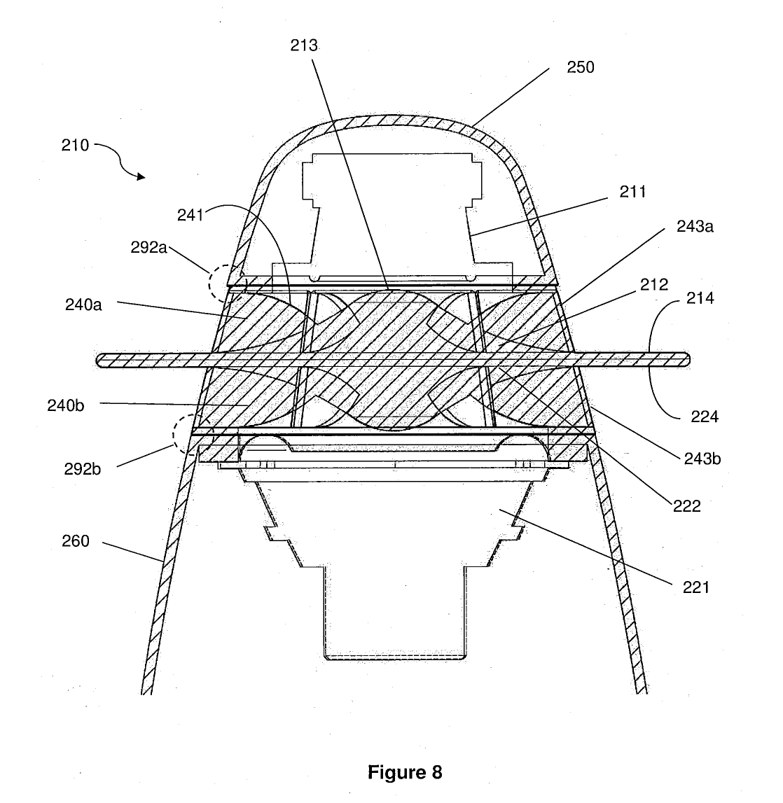

FIG. 8 shows the mid-range frequency driver and tweeter portions of a second embodiment of the present invention. In this figure, the shape of the speaker 210 tapers from the housing 260 towards the apex of the speaker 210 at housing 250, where the thicker portion of the speaker 210 is towards its base. The deflectors 240a,b have an outermost part, furthest from the raised centres 213, 223 of waveguides 212, 222 and along the thick edge 243a,b, where the surface of the deflectors 240a,b is substantially continuous with the surface of the housings 250, 260, such that there is no discontinuity or abrupt transitions at areas 292a,b to create turbulence in the sound waves reflected off the waveguides 212, 222. This is in contrast to the embodiment of FIGS. 1 to 3 where the surface of the outermost part of the deflectors 40 is not continuous with the peripheral surface of the speaker 10 and said surface is substantially vertical, parallel to the axis 99.

The surface of the outermost part may be straight alorig the entire part and inclined from a vertical axis, or curved where the curvature of the outermost part follows the curvature of the entire outer surface of the speaker 210. With the arrangement of speaker 210 in FIG. 8, the effective area of the deflectors 240b on the mid-range frequency waveguide 222 is greater than that of the effective area of the deflectors 240a on the tweeter waveguide 212. Accordingly, the sound waves reflected off the waveguides 212, 222 have more time and area to interact with the surfaces of the deflectors on waveguide 222 compared to waveguide 212, such that they are distributed and dispersed more effectively.

A third embodiment of the present invention is shown in FIG. 9, where the speaker 310 has a general tapered shape like that of FIG. 8, however, the deflectors 340 have a concave spine 341. According to FIG. 9, the waveguides 312, 322 and their respective deflectors 340, may be secured, fastened and attached to the housings 350, 360 via suitable fasteners 390 that are located within a cavity 391 passing through the deflectors 340 and waveguides 312, 322. These fasteners 390 may be anything suitable for fastening the structure of speaker 310 together and can include screws, rivets and nails. Preferably, the fastener cavity 391 does not have an opening in the chamber between each driver 311, 321 and their corresponding waveguides 312, 322 because an opening may create discontinuities and/or abrupt transitions in the entire surface of the waveguides 312, 322 and the deflectors 340, thereby creating turbulence in the reflected sound waves. Therefore, it is preferred that the fastener cavity 391 is an open-ended cavity, with one end opening at the portion 380a of a deflector 340 located on the tweeter waveguide 312, and the other end opening at the corresponding portion 380b of a deflector 340 on the mid-range frequency waveguide 322, such that the fastener 390 may be located through the waveguides 312, 322 and the deflectors 340, without affecting their smooth surfaces. It would be understood that the fasteners 390 and their respective cavities 391 may also be omitted entirely from the speaker 310, and suitable adhesives are used instead to hold the speaker structure together.

From the foregoing disclosure and detailed description of certain embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. An omnidirectional speaker comprising:
at least one speaker driver;
at least one waveguide corresponding to the at least one speaker driver; and
two or more tapered soundwave deflectors arranged radially on the at least one waveguide;
such that in use, the soundwave deflectors are adapted to distribute and disperse sound waves produced by the at least one speaker driver and reflected off of the at least one waveguide.

2. The omnidirectional speaker according to claim 1, wherein the soundwave deflectors have a thick edge and a thin edge, the soundwave deflectors tapering from the thick edge to the thin edge, wherein the thin edge is closer to the centre of the waveguide than the thick edge.

3. The omnidirectional speaker according to claim 1, wherein the soundwave deflectors have a smooth outer peripheral surface, free of irregularities, discontinuities and/or abrupt transitions.

4. The omnidirectional speaker according to claim 1, wherein the at least one waveguide has a differentiable surface.

5. The omnidirectional speaker according to claim 1, wherein the at least one waveguide has a smooth surface, free of irregularities, discontinuities and/or abrupt transitions.

6. The omnidirectional speaker according to claim 1, wherein the surface of the at least one waveguide is continuous with the surface of the soundwave deflectors, such that the transition between the two surfaces is smooth and free of irregularities, discontinuities and/or abrupt transitions.

7. The omnidirectional speaker according to claim 1, the omnidirectional speaker having 2 to 10 soundwave deflectors on the at least one waveguide.

8. The omnidirectional speaker according to claim 1, wherein the soundwave deflectors are identical in shape, size and height, and are located at the same distance from the centre of the waveguide, as well as from each other, on the at least one waveguide.

9. The omnidirectional speaker according to claim 1, wherein the at least one waveguide has a base with a raised centre, the raised centre facing the at least one speaker driver.

10. The omnidirectional speaker according to claim 9, wherein the at least one waveguide tapers in a concave manner from the base to the raised centre.

11. The omnidirectional speaker according to claim 9, wherein the at least one waveguide is convex.

12. The omnidirectional speaker according to claim 1, wherein the at least one speaker driver has a first diameter, and the at least one waveguide has a second diameter, and wherein the second diameter is larger than the first diameter.

13. The omnidirectional speaker according to claim 1, the omnidirectional speaker further comprising a housing.

14. The omnidirectional speaker according to claim 12, wherein the part of the surface of the soundwave deflectors furthest from the centre of the at least one waveguide, is substantially continuous with the peripheral surface of the housing.

15. The omnidirectional speaker according to claim 1, the omnidirectional speaker having two speaker drivers: a first high frequency driver and a second mid-range frequency driver.

16. The omnidirectional speaker according to claim 14, the omnidirectional speaker having two waveguides: a first high frequency waveguide corresponding to the first high frequency driver and a second mid-range frequency waveguide corresponding to the second mid-range frequency driver.

17. The omnidirectional speaker according to claim 15, wherein the first high frequency driver faces the second mid-range frequency driver.

18. The omnidirectional speaker according to claim 16, wherein the high and midrange frequency waveguides are positioned between the first high frequency driver and the second mid-range frequency driver so as to block a direct path from the first high frequency driver to the second mid-range frequency driver.

19. The omnidirectional speaker according to claim 14, the omnidirectional speaker further includes a low frequency driver.
